(19) United States
(12) Patent Application Publication
(10) Pub. No.: US 2011/0031870 A1
(43) Pub. Date: Feb. 10, 2011

(54) Convenient-used Energy-saving ceiling lamp

(76) Inventor: Yuenong Wang, Nanjing, Jiangsu (CN)

Correspondence Address: ZHEN ZHENG LU, 1730 HUNTINGTON DRIVE #304, DUARTE, CA, 91010, US

(21) Appl. No.: 12/936,898

(22) PCT Filed: Mar. 27, 2009
(86) PCT No.: PCT/CN09/71042

§ 371 Date: Oct. 7, 2010

(51) Int. Cl. F21S 8/04

(52) U.S. Cl. 313/323

(57) ABSTRACT

A convenient-used energy-saving ceiling lamp comprises a lamp base, a lamp head, a ballast, a light tube, a lampshade and a lamp holder. The lamp holder is directly mounted on the lamp base. The ballast is made to form a concave or hollow area in the center of it, which is big enough to allow the lamp head to be mounted in there and to be plugged easily into the lamp holder, thereby reducing the whole height of the light tube. The light tube is connected with the ballast via ribs. The lamp head and lamp holder can use the screw type, bayonet type, double-ended bayonet type applied in glow starters, and pin type plug and socket applied in double D type ordinary light tubes. The obvious advantage is the convenience to install, use and maintain it.

### BACKGROUND

1. Field of the Invention

The present invention relates to the field of lamp technology, especially, to energy-saving ceiling lamps with a lampshade, which are easy to be used and maintained; namely, convenient-used energy-saving ceiling lamps.

2. Brief Description of Related Arts

In the current technology, ceiling lamps with a lampshade are mainly consisting of a ballast, light tubes, and connectors for installing the tubes inside the lampshade. Ceiling lamps with this structure have a main shortcoming that workers have difficulties to install and fix them, especially when working aloft, because the ballast is connected with the lamp base through a lot of screws and wires, which is not only takes much time but also dangerous for a non-electrician. Besides, due to the short lifetime and inconvenient maintenance of electric ballasts and tubes, this type of ceiling lamps with a lampshade does not work normally in many situations, which affects greatly the illumination and decoration.

Chinese patents, numbered ZL200620068203.5, ZL200620069762.8, and ZL200620070386.4,have overcome the problems of installation and maintenance. However, the light tube in these patents is too high to be put inside the ceiling lamps with a popularly sold lampshade in the current marketplace, which has a small diameter, unless process a new mould to produce a new lampshade with higher or deeper size. Nevertheless, it will increase the cost of production and bring about more inconvenience.

### SUMMARY OF THE PRESENT INVENTION

The objective of the present invention is to provide a ceiling lamp with a lampshade to overcome the shortcomings of current technologies, which is easy to be installed and maintained, and has obvious effects of energy saving and longer lifetime; namely, to provide a convenient-used energy-saving ceiling lamp and its special tubes with new structures.

Unlike the current technology, which has a single light tube and a ballast installed inside the lampshade, specifically connected with the lamp base through a lot of connectors, the present invention takes away all of these components, and instead, install a lamp holder directly in the lamp base.

Therefore, the present invention comprises a lamp holder, a lamp head, a ballast, and a light tube. The ballast is configured to take on a concave or hollow shape in the center of it; the concave or hollow area is big enough to allow the lamp head to be mounted in there, and to be plugged easily into the lamp holder as well. The ballast and tube are connected through ribs. By way of this structure, the overall height of the light tube is greatly reduced, and it only takes a few minutes to install or fix the tube inside the lampshade.

The lamp head and lamp holder used in the present invention can be screw type, bayonet type, double-ended bayonet type applied in glow starters, or pin type plug and socket applied in current double D type ordinary light tubes; other types of lamp head and lamp holder and connectors can be used too. When the double-ended bayonet lamp head and lamp holder used in the glow starter, or the pin type plug and socket used in current double D type ordinary tubes are adopted, the ballast can be made to have a concave or hollow shape in its central area, or not to have.

The light tube can be made just one or more in different shapes, such as triangle, square, rectangle, diamond, spiral, wavy, and etc.; it can be also made in the shape of a wheel, a triangle, a diamond, and etc., each with multiple spokes.

According to different requirements, one or more lamp holders can be installed in the ceiling lamp.

In one word, even if there is no limitation to choose the shape or structure of an energy-saving lamp, the bottom line is that the energy-saving lamp can be easily put inside the lampshade mentioned above, which is of small height and sold popularly in the markets. In addition, the overall illumination effect and durability have to be considered as well. As to the light source, other types of energy-saving lamps can also be adopted.

The present invention has the following advantages: because the single ballast and connectors for installing tubes are dispensed with; instead, a lamp holder is directly installed; therefore, the whole structure of the ceiling lamp with a lampshade becomes simple, and in turn reduces the cost of production. Moreover, because the overall height of tubes are reduced, it is very easy to put the light tubes inside the lampshade of the ceiling lamp; thus, various lampshade sold in current markets all can be used; other extra moulds for producing new lampshades with higher size do not be needed, which reduces the cost of production drastically. By using the light tube of the present invention, the overall illumination is very even, and the quality and effect have improved a lot.

The most obvious advantage of this invention is its convenience of installation, use and maintenance. What the users needs to do, if the lamp is broken, is just to twist the lamp head to make it released from the lamp holder, and then take out the ballast and change a new ballast or new light tube, without asking an electrician to loose all connectors and wires, which is not only time-consuming but also dangerous.

Because the new type of energy-saving lamps are used in this invention, the effect of energy saving is quite big, and the lifetime is longer. From the other perspective, the improved energy-saving lamp can be made in different shapes and colors for the purpose of illumination or decoration.

### BRIEF DESCRIPTION OF DRAWINGS

FIG. 1 is the schematic diagram of the structure of one embodiment of the present invention;

FIG. 2 is the front view of the light tube of one embodiment of the present invention;

FIG. 3 is the vertical view of the light tube of one embodiment of the present invention.

In the drawings, the reference number 1 represents a screw lamp head, 2 represents a ballast, 3 represents a circular light tube, 4 represents heat radiation holes, 5 represents heat radiation openings, 6 represents a lampshade, and 7 represents a lamp holder.

### DETAILED DESCRIPTION OF THE PREFERRED EMBODIMENTS

Referring to FIG. 1, after removing the single ballast, light tube and other connectors inside the lampshade of the ceiling lamp of the current technology, install directly a lamp holder inside, specifically, mount the lamp holder in the lamp base, which is installed on the ceiling.

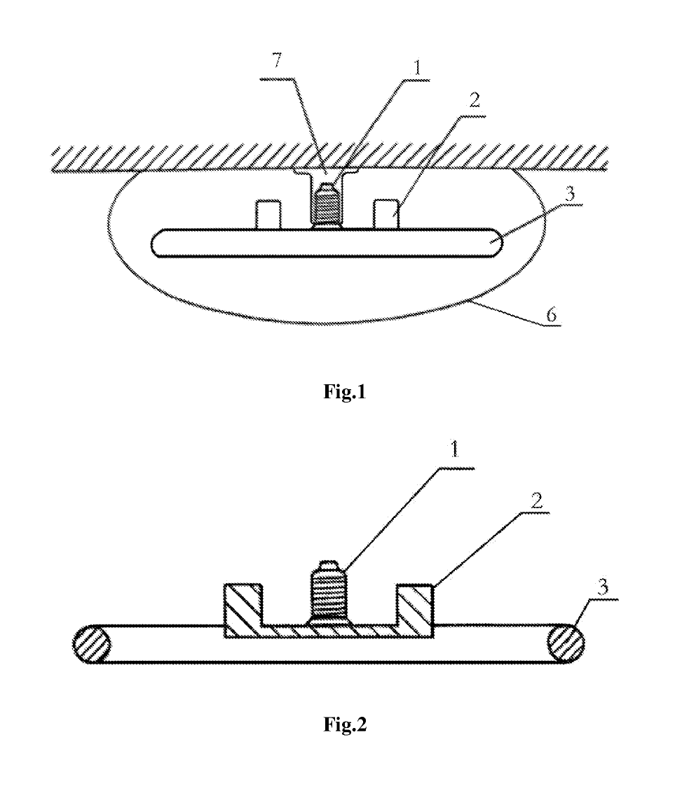

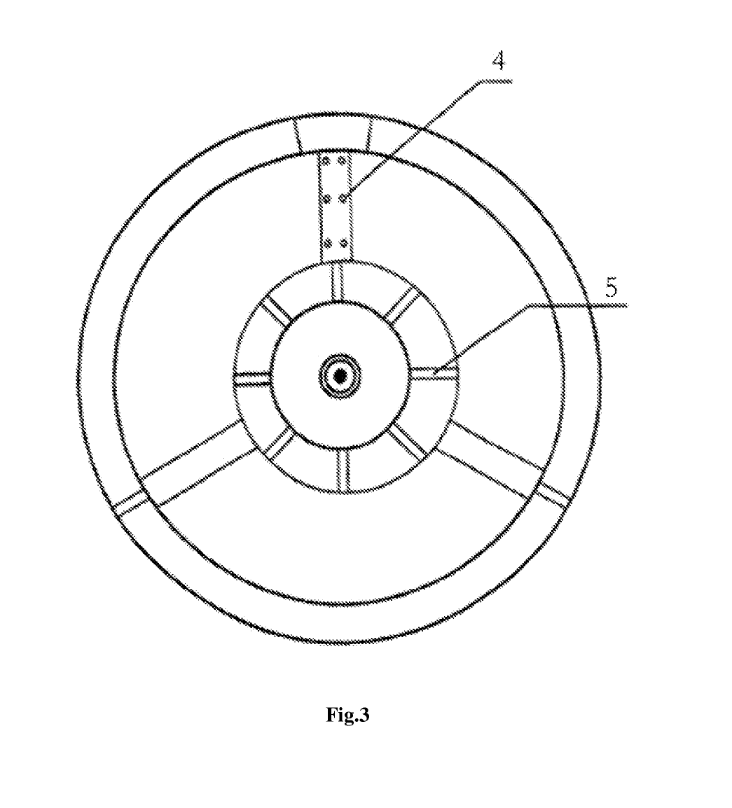

Referring to FIG. 2, make a big enough concave or hollow space in the center of the ballast in order to allow a lamp head to be mounted in there and to be easily plugged into the lamp holder. By way of this structure, the overall height of the lamp tube can be reduced greatly. The light tube can be set in a place which is lower a bit than the ballast, so as to avoid the shadow resulting from uneven illumination. The ballast and light tube are connected through ribs.

Then put a special light tube inside the lamp. By doing this, a convenient-used energy-saving ceiling lamp just comes out. The ceiling lamp in FIG. 1 and FIG. 2 is just one embodiment of the present invention.

The connection methods between the lamp head and lamp holder have various choices. For example, if the double-ended bayonet lamp head and lamp holder that are used in the glow starter, or the pin type lamp head and lamp holder that are used in the double D type light tube, are adopted, the ballast can be made with a concave or hollow area in the center of it, or just dispense with the concave or hollow structure.

The light tube of the present invention can have different shapes and ways to connect with the ballast. Whatever shapes or connection ways are used, the basic principle has to be met; that is, the energy-saving lamps can be easily installed inside the lampshade. Of course, the light source can use other different lamps and lanterns.

One skilled in the art will understand that the embodiments of the present invention as shown in the drawings and described above is exemplary only and not intended to be limiting.

It will thus be seen that the objects of the present invention have been fully and effectively accomplished. Its embodiments have been shown and described for the purpose of illustrating the functional and structural principles of the present invention and is subject to change without departure from such principles. Therefore, this invention includes all modifications encompassed within the spirit and scope of the following claims.

1. A convenient-used energy-saving ceiling lamp, comprising:
a lamp base;
a lamp holder;
a lamp head;
a light tube;
a ballast;
and a lampshade,
wherein the ballast is made to have a concave or hollow area in the center of it, which is big enough to allow the lamp head to be mounted in there and to be plugged easily into the lamp holder as well;
the ballast and light tube are connected through ribs.

2. The convenient-used energy-saving ceiling lamp set forth in claim 1, wherein the type of the lamp head and lamp holder is selected from the group consisting of screw type, bayonet type, double-ended bayonet type applied in glow starters, and pin type plug and socket applied in double D type ordinary light tubes;
when the double-ended bayonet lamp head and lamp holder used in the glow starter, or the pin type plug and socket used in current double D type ordinary tubes are adopted, the ballast can be made to have a concave or hollow shape in its central area, or not to have.

3. The convenient-used energy-saving ceiling lamp set forth in claim 1, wherein one or more lamp holders can be installed inside the lampshade; one or more light tubes can be installed.

4. (canceled)
